(19) United States
(12) Patent Application Publication
(10) Pub. No.: US 2007/0070886 A1
(43) Pub. Date: Mar. 29, 2007

(54) Modifying an endpoint node connection associated with a destination

(76) Inventor: Seth Zirin, Folsom, CA (US)

Correspondence Address: INTEL CORPORATION;C/O INTELLEVATE, LLC, P.O. BOX 52050, MINNEAPOLIS, MN, 55402, US

(21) Appl. No.: 11/238,417

(22) Filed: Sep. 29, 2005

(51) Int. Cl. H04J 3/14

(52) U.S. Cl. 370/225

(57) ABSTRACT

In an endpoint node coupled to a network, a method that includes detecting a trigger indicating data transmitted using a connection associated with the destination is undeliverable, the connection to include an egress port to transmit the data from the endpoint node and a network address for the destination. The method to also include modifying the connection based, at least in part, on detecting the trigger. The connection modification to include either a different egress port to transmit the data from the endpoint node, a different network address for the destination or both a different egress port to transmit the data from the endpoint node and a different network for the destination. The data is then transmitted using the modified connection.

### BACKGROUND

Many networking, communications, and telecommunications systems typically require highly-reliable, high-speed, low-latency connectivity among networks of devices that are interconnected through fabrics or other types of communication links. Either because of the specific features of the applications used in these systems or their generally stringent reliability requirements, these systems need to quickly failover or switchover to use another connection when problems are encountered with a connection. For example, a switchover for a connection between a pair of interconnected devices may result in a switchover to another connection that is rerouted along an alternate communication link path.

Typically, implementing a switchover within a very small time interval (low-latency) has resulted in the use of expensive, application-specific mechanisms, based on proprietary communication links or interconnects. Additionally, typical software used with low-cost, general-purpose mechanisms may have an unacceptably high latency that may not meet tight timing constraints when this software implements a switchover. Thus to meet low latency requirements, application-specific, inter-device wiring may be needed. This may be problematic to implementing low-cost and reliable systems that are designed or operated according to various industry standards that encourage general-purpose, modular systems using non-proprietary solutions. One such industry standard is the PCI Industrial Computer Manufacturers Group (PICMG), Advanced Telecommunications Computing Architecture (ATCA) Base Specification, PICMG 3.0 Rev. 1.0, published Dec. 30, 2002, or later versions of the specification (“the ATCA specification”).

### BRIEF DESCRIPTION OF THE DRAWINGS

FIG. 1 is an example illustration of elements of an endpoint node to transmit data using a connection;

FIG. 2 is a block diagram of an example connection manager architecture;

FIG. 3a is an example illustration of elements of a switchover logic to modify a connection;

FIG. 3b is an example illustration of a connection table to show what tuples are active prior to modification of an active index of a connection entry;

FIG. 3c is an example illustration of the connection table to show what tuples are active after modification of the active index of the connection entry;

FIG. 4 is a flow chart of an example method to switchover to transmit data using a modified connection; and

FIG. 5 is an illustration of an example electronic system.

### DETAILED DESCRIPTION

As mentioned in the background, a software implemented switchover may not meet tight timing constraints when used with low-cost, general-purpose mechanisms. The delay or high latency in implementing a software-based switchover may lead to a hardware implemented switchover, e.g., within a node on a communication link with little or no external software intervention. This hardware implementation may meet the low-cost, general-purpose/modular objectives of some industry standards and also meet the tight timing constraints required for most networking, communications and telecommunications systems.

In one example, an endpoint node coupled to a network transmits data to a destination using a connection associated with the destination. The connection may be a logical connection and includes an egress port to transmit the data from the endpoint node and a network address for the destination. The endpoint node may detect a trigger that indicates the data transmitted using the connection is undeliverable and may modify the connection. The modification may include either a different egress port to transmit the data from the endpoint node, a different network address for the destination or both a different egress port to transmit the data from the endpoint node and a different network address for the destination. The endpoint node may then switchover to transmit the data using the modified connection.

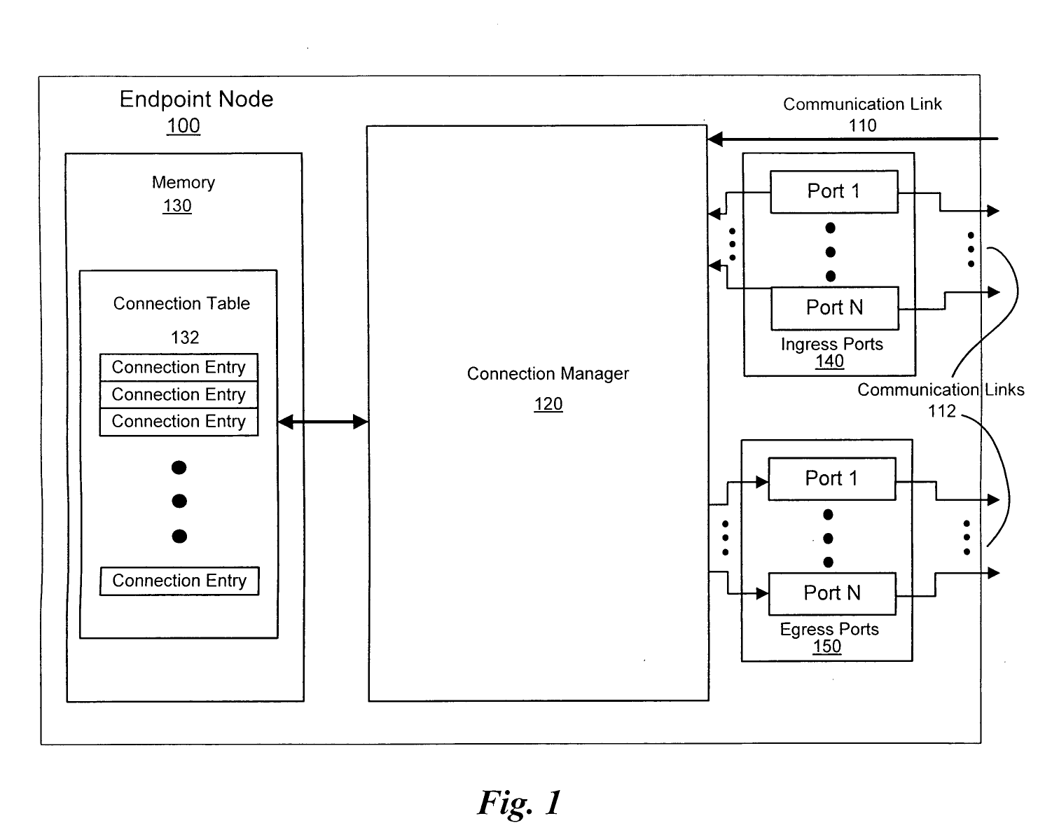

FIG. 1 is an example illustration of elements of an endpoint node 100 to transmit data using a connection. In FIG. 1, endpoint node 100 is depicted as including a connection manager 120, a memory 130, ingress ports 140 and egress ports 150. In one example, endpoint node 100 is coupled to a network (e.g., via communication links 112) and transmits data to a destination using a connection associated with the destination. The network may be a packet-based network and operate in compliance with one or more industry standards such Ethernet, Advanced Switching Interconnect (ASI), Synchronous Optical NETwork (SONET), Asynchronous Transfer Mode (ATM), IEEE 802.11, or IEEE 802.16. A connection may include an egress port from among egress ports 150 to transmit the data to a destination and a network address for the destination.

In one example, each egress port of egress ports 150 couples to communication links 112. Communication links 112 may include a plurality of communication links that may each couple to elements of a network such as switches, nodes or other devices. Communication links 112 may connect to different elements of the same network or to completely different networks. In some examples, the networks may be parallel instances of the same interconnect technology and in more elaborate examples the networks may be parallel instances of different networks operating in compliance with one or more industry standards, e.g., ASI, Ethernet, SONET, ATM, etc. These different networks may each use different network address formats.

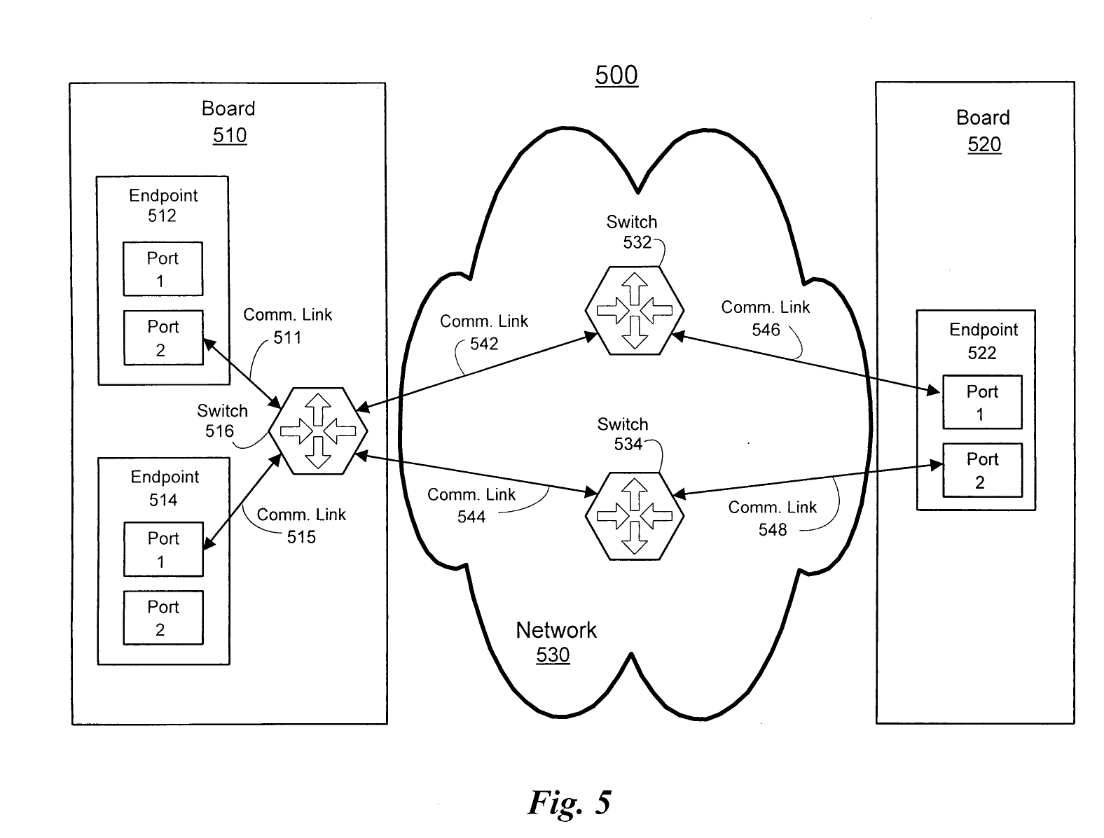

As described in more detail in FIG. 5, data transmitted through a given egress port may follow a particular route or path through one or a series of communication links coupled to elements of the network to reach a destination. The network address for the destination of the data (e.g., a given ingress port that couples to the network at the destination) may also influence the particular route or path the data takes to reach the destination. Thus, a connection may be a logical construct that includes both the egress port and the network address for the destination and may determine the route or path the data follows to reach the destination.

In one implementation, connection manager 120 is resident on or responsive to endpoint node 100. Connection manager 120, in one example, detects a trigger that indicates data transmitted using a connection is undeliverable, modifies the connection based on detecting the trigger, and then enables endpoint node 100 to switchover to use the modified connection to transmit data to the destination.

In one example, the trigger detected by connection manager 120 may have been transmitted or forwarded from elements of the network coupled to ingress ports 140 via communication links 112 or coupled directly to endpoint node 100 or connection manager 120 via communication link 110. The trigger may indicate that one or more elements (e.g., switches, devices, nodes, etc.) used to transmit or forward the data through the network are not responding or that the destination is not responding or is unable to receive the data. Although these are only two examples of the many possible triggers that connection manager 120 may detect.

As depicted in FIG. 1, endpoint node 100 includes memory 130. Memory 130 may be resident on or responsive to endpoint node 100 and may include a connection table 132. In one example, connection table 132 includes a plurality of connection entries. As described in more detail below, each connection entry may include information for a connection associated with a destination. This information may include the egress port and the network addresses for a destination for a connection associated with the destination. In another example, connection entries in another connection table may also be in a memory responsive to or accessible to endpoint node 100.

In one example, connection manager 120 detects a trigger that indicates data transmitted using a connection associated with a destination is undeliverable or cannot be properly received. Connection manager 120 based, at least in part, on the detected trigger may access connection table 132. As described in more detail below, connection manger 120 may modify an index for the connection entry of the connection. Connection manager 120 may then use the modified index for the connection entry to modify the connection associated with the destination and facilitate or enable endpoint node 100 to switchover to a modified connection and transmit the data from egress ports 150 using the modified connection.

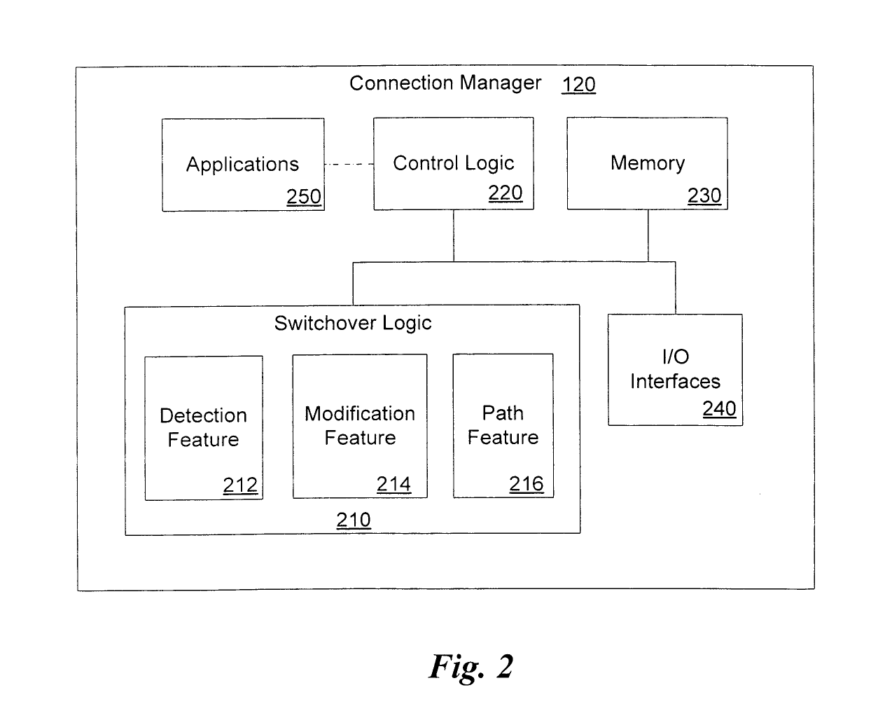

FIG. 2 is a block diagram of an example connection manager 120 architecture. In FIG. 2, connection manager 120 includes switchover logic 210, control logic 220, memory 230, input/output (I/O) interfaces 240, and optionally one or more applications 250, each coupled as depicted.

In FIG. 2, switchover logic 210 includes detection feature 212, modification feature 214 and path feature 216. In one implementation, these features detect a trigger that indicates data transmitted from an endpoint node (e.g., endpoint node 100) using a connection associated with a destination is undeliverable. These features may then modify the connection based on the detected trigger and then enable the endpoint node to use the modified connection to transmit the data to the destination.

Control logic 220 may control the overall operation of connection manager 120 and may represent any of a wide variety of logic device(s) or executable content to implement the control of connection manager 120. In this regard, control logic 220 may include a microprocessor, network processor, microcontroller, field programmable gate array (FPGA), application specific integrated chip (ASIC), or executable content to implement such control features, or any combination thereof. In alternate examples, the features and functionality of control logic 220 may be implemented within switchover logic 210. In these alternate examples, switchover logic 210 may represent the same variety of logic device(s) as listed above for control logic 220.

According to one example, memory 230 is used by switchover logic 210 to temporarily store information. For example, information related to a modified connection associated with a destination that enables the endpoint node to use the modified connection to transmit data to the destination (e.g., a different egress port or network address). Memory 230 may also contain information used by switchover logic 210 to determine whether or not a switchover is to be initiated. Memory 230 may also include encoding/decoding information to facilitate the detection of triggers and communicating a switchover based on the detected trigger. In one implementation, memory 230 may be located as a block of memory within memory 130.

I/O interfaces 240 may provide a communications interface via a communication medium or link between connection manager 120 and an endpoint node or an electronic system. As a result, control logic 220 can receive a series of instructions from application software external to connection manager 120 via I/O interfaces 240. The series of instructions may activate control logic 220 (e.g., at start-up of an endpoint node) to implement one or more features of switchover logic 210.

In one example, connection manager 120 includes one or more applications 250 to provide internal instructions to control logic 220. Such applications 250 may be activated to generate a user interface, e.g., a graphical user interface (GUI), to enable administrative features, and the like. For example, a GUI may provide a user access to memory 230 to modify or update information to facilitate the detection of triggers and communicating a switchover based on the detected trigger.

In another example, applications 250 may includes one or more application interfaces to enable external applications to provide instructions to control logic 220. One such external application could be a GUI as described above.

In one implementation, switchover logic 210 may activate detection feature 212 to determine whether a trigger has been received by endpoint node 100. The trigger may indicate that data transmitted from endpoint node 100 to a destination using a connection associated with the destination is undeliverable. Detection feature 212 may detect the trigger through one or more communication links coupled to endpoint node 100 or to connection manager 120, e.g., communication links 112 or communication link 110.

In one example, a trigger may be received by endpoint node 100 or detection feature 212 via communication link 110. Communication link 110 may be a side-band communication link coupled to endpoint node 100 or connection manager 120 to receive signals from elements which may facilitate data transmission (e.g., fabric interfaces, header processing logic, switches, routers, memory controllers, etc.). Communication link 110, in one example, may also be a management bus via which detection feature 212 may receive triggers via data packets including content indicating error conditions in elements which may facilitate data transmission.

In another example, a trigger may be included in a data packet received via communication links 112. These data packets may be received via ingress ports 140 from network elements (e.g., a switch) coupled via communication links 112 (in-band communication links). Detection feature 212 may include or obtain (e.g., from memory 230) information to decode these data packets to determine, for example, the cause or event that resulted in the trigger. The event may include, but is not limited to, a receiver error, a communication link failure, a routing error, a switch error, a cyclic redundancy check error, etc.

In one implementation, a trigger may be associated with the modification of more than one connection. So a trigger indicating data transmitted from endpoint node 100 to a destination using a connection associated with the destination is undeliverable may also indicate that other connections associated with other destinations are about to fail. Based on the trigger, connection manager 120 may modify other connections to enable endpoint node 100 to use the other modified connections to transmit data to those other destinations. This modification of other connections may be based on a knowledge mechanism (e.g., maintained in memory 230) that provides switchover options for these other connections. Thus, endpoint node 100 may proactively switchover to one or more other modified connections based on at least one trigger and the knowledge mechanism.

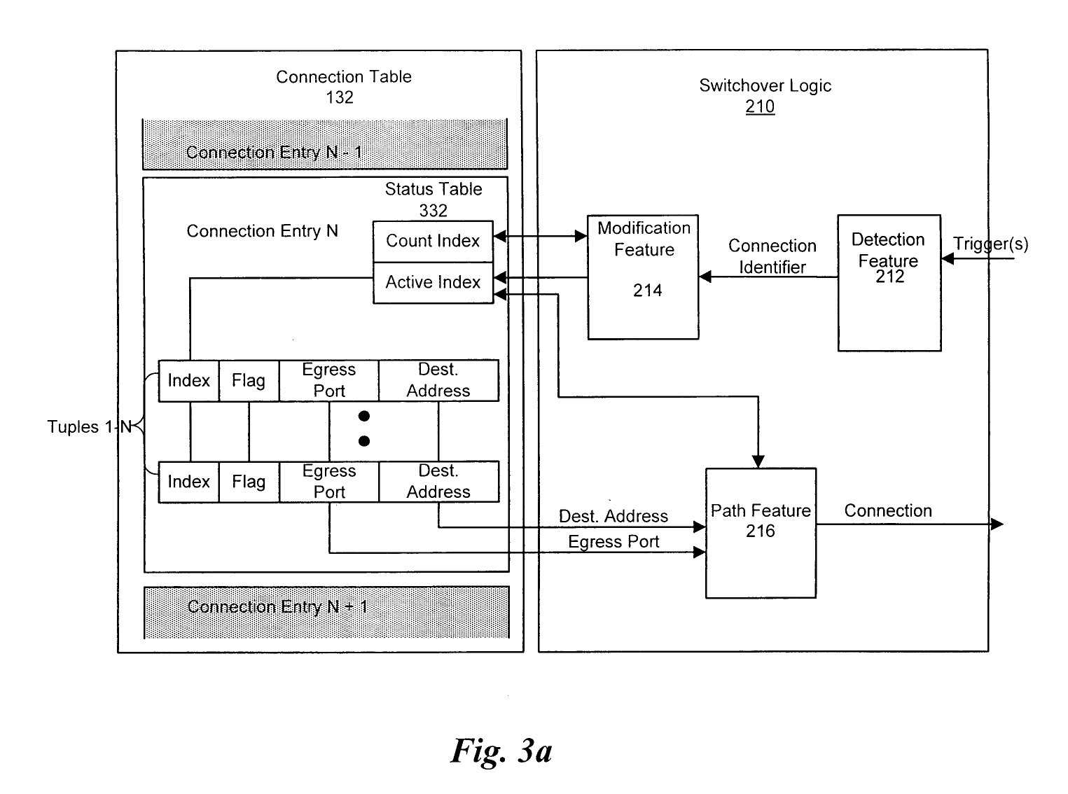

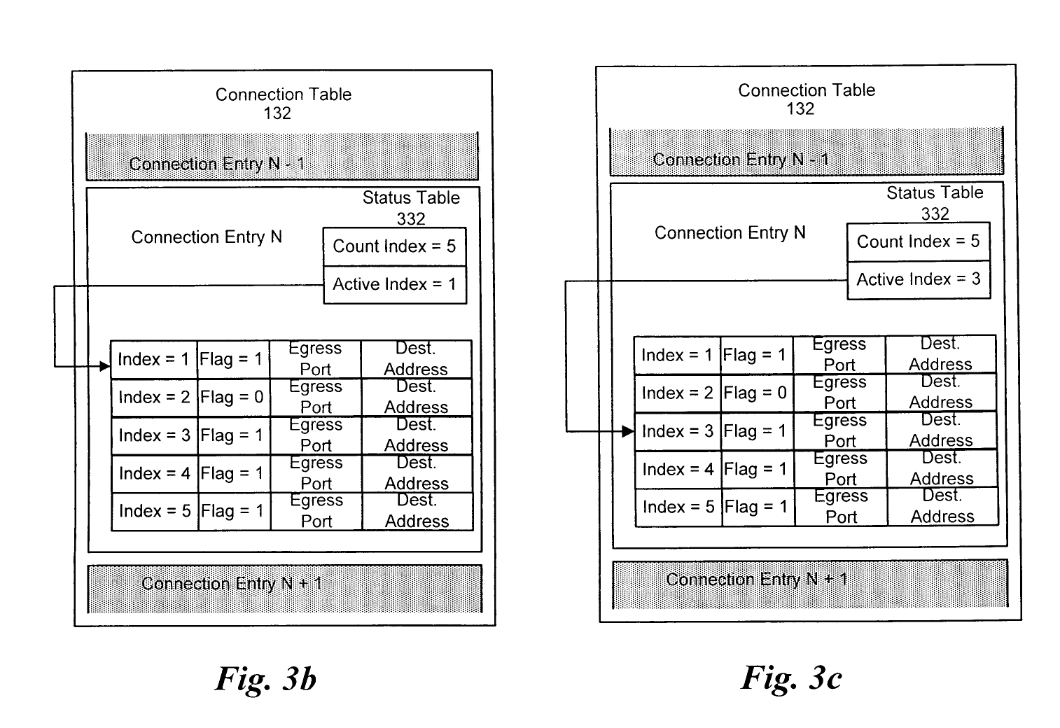

In one example, based at least in part on the trigger, switchover logic 210 activates modification feature 214. Modification feature 214 may receive from detection feature 212 an indication of which connection associated with the destination was related to the trigger. Modification feature 214 may then access connection table 132 (e.g., in memory 130) to modify an active index for the connection entry containing information for that connection. As explained in more detail in FIG. 3a, modifying the active index for the connection entry may result in modifying the connection associated with the destination. The modified connection, in one example, to include either a different egress port to transmit the data from endpoint node 100, a different network address for the destination, or both a different egress port to transmit the data from endpoint node 100 and a different network address for the destination.

Switchover logic 210, in one example, may then activate path feature 216 to use information for the modified connection (e.g., the modified active index) to facilitate or enable endpoint node 100 to transmit the data from endpoint node 100 to the destination. In one example, path feature 216 may assist in directing the data to the proper egress port of egress ports 150 and may also encode routing information (e.g., in a header). Both the directing to the proper egress port and the routing information may enable endpoint node 100 to use the modified connection to transmit the data to the destination.

FIG. 3a is an example illustration of elements of switchover logic 210 to modify a connection associated with a destination. According to one example, FIG. 3a shows the interaction between elements of switchover logic 210 in connection manager 120 and a connection entry maintained in connection table 132.

In one implementation, each connection entry in connection table 132 (e.g., maintained in memory 130) includes an ordered set of addressing values or “tuples,” and a status table. As depicted in FIG. 3a for connection entry “N”, tuples 1 to N each include an index identifier, an egress port identifier, a network address for the destination, and an enable flag that denotes whether the tuple can be used. One or more tuples may be associated with an index identifier to indicate which tuple or tuples are currently active for the connection. The index identifier may be maintained in status table 332 as the active index. A count index may also be included in table 332. The count index may include the number of index identifiers included in each connection entry.

In one example, a tuple can be used if it is configured for a connection. A tuple may be configured if a communication link associated with the egress port has been established and the network address for the destination has been found to be a valid network address. Thus, a tuple's enable flag may be asserted (e.g., =1) if the tuple was previously configured for the connection or unasserted (e.g., =0) if not configured. A tuple's enable flag may also be unasserted if the egress port or the network address included in the tuple were found to have delivery problems (e.g., the network address changed, the communication link became inoperable, the egress port was disabled or failed, etc.). These enable flags may become asserted if the tuple later does become configured or the delivery problems are resolved.

FIG. 3b is an example illustration of connection table 132 to show what tuples are active prior to modification of the active index of connection entry N. As shown in FIG. 3b, connection entry N includes 5 tuples that are each associated with an index identifier 1-5, respectively. Enable flags are asserted for tuples associated with index identifiers 1 and 3-5 and unasserted for a tuple associated with index identifier 2. In status table 332, a count index reflects the number of index identifiers as 5 and an active index of 1 indicates that a tuple associated with index identifier 1 is active for connection entry N.

FIG. 3c is an example illustration of connection table 132 to show what tuples are active after modification of the active index of connection entry N. As shown in FIG. 3c, the active index value in status table 332 has been modified to indicate that a tuple associated with index identifier 3 is now the active tuple for connection entry N.

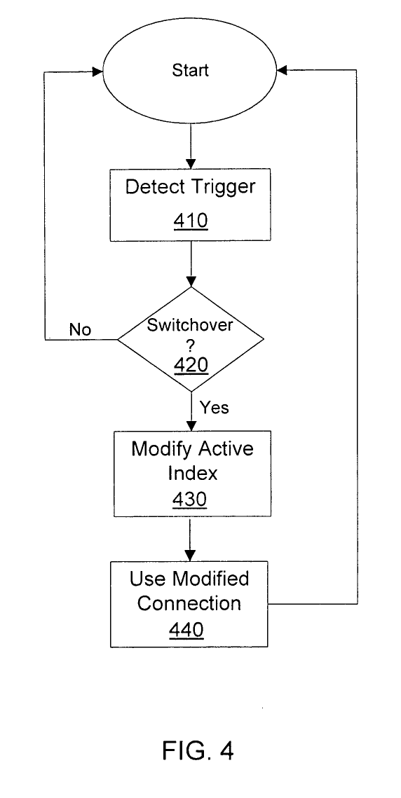

FIG. 4 is a flow chart of an example method to switchover to transmit data using a modified connection. In one implementation, the example method is implemented in endpoint node 100 by switchover logic 210, as depicted in FIG. 3a. Thus, in this implementation, connection manager 120 has already activated switchover logic 210.

In block 410, in one example, switchover logic 210 activates detection feature 212 to detect a trigger that indicates data transmitted from endpoint node 100 using a connection associated with a destination is undeliverable. As described above, the trigger may be in a data packet received via communication links 112 (in-band) coupled to ingress ports 140 or in a signal or data packet received via communication link 110 (side-band).

In block 420, based on the detected trigger, detection feature 212 may determine whether the trigger should result in switchover logic 210 activating modification feature 214 and path feature 216 to enable endpoint node 100 to switchover and use a modified connection to transmit the data to the destination. This determination may be based, at least in part, on a trigger filter policy (e.g., maintained in memory 230). This filter policy may include a set of conditions that detection feature 212 uses to determine whether or not a switchover is to occur. If the filter policy indicates that the detected trigger does not result in a switchover to a modified connection the process starts over.

In block 430, based on detection feature 212 determining that the filter policy indicates that the detected trigger is to result in a switchover to a modified connection, switchover logic 210 activates modification feature 214. In one example, modification feature 214 may receive an indication from detection feature 212 via a connection entry identifier to indicate to modification feature 214 which connection entry is related to the detected trigger. This connection entry identifier may correspond to connection entry N depicted in FIG. 3b.

Modification feature 214 may access status table 332 of the connection entry that matches the connection entry identifier provided by detection feature 212. In one example, status table 332 may be associated with a single connection entry. In another example, status table 332 may be associated with multiple connection entries. In this other example, the active index value may identify the active tuples in each connection entry associated with that active index value. Thus, a trigger associated with one connection may result in the modification of an active index value associated with multiple connection entries for one or more other connections.

In one example depicted in FIG. 3b for connection entry N, modification feature 214 first accesses the count index in table 332 to determine the number of index identifiers associated with connection entry N. Modification feature 214 then modifies connection entry N's active index by incrementing the active index by a given value and comparing the resulting incremented active index value to the index count.

In one example, if the incremented active index value is greater than the index count then the active index value is reset (e.g., to 1). If not greater, modification feature 214 may check the enable flag of each tuple associated with the incremented active index value to verify that at least one enable flag is asserted. If no enable flags are inserted, modification feature 214 then increments the index value again, compares the newly incremented index value to the index count and checks the enable flags. This process may continue until the active index is incremented back to the value of the original (non-modified) active index value. At that point, the switchover sequence is halted and an error message may be forwarded to connection manager 120.

In one implementation, the active index of connection entry N shown in FIG. 3b is incremented from a value of 1 to a value of 2. Since the count index equals 5 and 2 is not greater than 5, the count is not reset. However, the enable flag for the tuple associated with index identifier 2 is unasserted. As a result, the tuple associated with index identifier 2 is not usable. So modification feature 214 increments the active index identifier again, verifies the count index to the new value of 3 and checks the enable flag for the tuple associated with an index identifier of 3. Since the enable flag is asserted, the modified active index value is set to 3 by modification feature 214 as shown in FIG. 3b.

In one example, modification feature 214 has incremented the active index value and verified that at least one tuple has an asserted enable flag. Thus, the incremented active index may refer to a tuple for a modified connection that includes either a different egress port to transmit the data from endpoint node 100, a different network address for the destination or both a different egress port and a different network address.

In block 440, switchover logic 210 activates path feature 216. In one example, path feature 216 may access the connection entry for a connection associated with the destination. Path feature 216 may also access the newly incremented active index value in status table 332 of the connection entry (e.g., active index of 3 for connection entry N) to determine which tuple is now active for the modified connection (e.g., the tuple or tuples associated with index identifier 3). Path feature 216 may use the active tuple information to facilitate or enable endpoint node 100 to transmit data to the destination using the modified connection.

In one example, the data to be transmitted to the destination may be transmitted from egress ports 150 via one or more data packets. Path feature 216 may encode the network address for the destination included in the active tuple in a portion of the one or more data packets (e.g., in a header) and also indicate based on the active tuple which port of egress ports 150 to transmit the one or more data packets. The process then starts over, for example if another trigger is detected.

FIG. 5 is an illustration of an example electronic system 500. In FIG. 5, endpoint nodes 512, 514 and 522 on boards 510 and 520 are coupled to network 530 via communication links 542, 544, 546 and 548. In one example, although not shown in FIG. 5, each endpoint node on boards 510 and 520 includes a connection manager 120 as described above. In one example, the elements of electronic system 500 may be part of a modular computing platform designed and operated in compliance with the ATCA specification. Thus, ATCA compliant boards 510 and 520 may couple to an ATCA compliant backplane (not shown) in the ATCA compliant modular computing platform. Switches 532 and 534 may also couple to the backplane and communication links 542, 544, 546, and 548 may be routed through the backplane. As a result, network 530 has a redundant, dual-star topography.

In one example, the two endpoint nodes 512 and 514 on board 510 may be mezzanine cards designed and operated in compliance with the an industry standard such as the Advanced Mezzanine Card (AMC) Specification, PICMG AMC.0, Revision 1.0, published Jan. 3, 2005, or later versions of the specification (“the AMC.0 specification). ATCA compliant board 510 may be a carrier board also designed and operated in compliance with the AMC.0 specification. In that regard, switch 516 may forward data to/from endpoint nodes 512 and 514 via communication links 511 and 515 to other elements coupled to network 530 (e.g., switches 532, 534, board 520).

In one example, the communication links depicted in FIG. 5 as coupling to switches 516, 532 and 534 are designed to forward data using one or more communication protocols associated with or described by sub-set specifications to the ATCA specification. These sub-set specifications are typically referred to as the “PICMG 3.x specifications.” The PICMG 3.x specifications include, but are not limited to, Ethernet/Fibre Channel (PICMG 3.1), Infiniband (PICMG 3.2), StarFabric (PICMG 3.3), PCI-Express/Advanced Switching Interconnect (PICMG 3.4) and Advanced Fabric Interconnect/S-RapidIO (PICMG 3.5).

In one implementation, the communication links coupled to switches 516, 532 and 534 may operate in compliance with PICMG 3.4 for PCI-Express/Advanced Switching. In this implementation, the elements of electronic system 500 may be designed to operate in compliance with the Advanced Switching Core Architecture Specification, Rev. 1.1, published November 2004, or later versions of the specification (“the AS specification”). In one example, endpoint node 512 may transmit data to endpoint node 522. This data may be encapsulated and tunneled using communication protocols described in the Advanced Switching specification and routed through the communication links coupled to switches 516, 532 and 534.

In the PICMG 3.4 implementation, endpoint node 512 may transmit data to endpoint node 522. This data may be transmitted using a connection associated with a destination. This connection may include the port via which endpoint node 512 is to transmit the data and also the network address for the port on endpoint node 514 through which the data is received by endpoint node 514. The example connection may include an egress port that transmits data through port 2 in endpoint node 512 to switch 516 via communication link 511. The example connection may also include a network address for the destination of port 1 on endpoint node 522. Thus, using the connection to transmit the data, the data follows a path from port 2 on endpoint node 512 to switch 516 via communication link 511, through switch 532 via communication links 542 and to port 1 on endpoint node 522 via communication link 546.

In one example, switch 516 may receive an indication that the data transmitted from endpoint node 512 to endpoint node 522 using the connection described above is not deliverable. This delivery problem may be a result of switch 532 failing or being removed from network 530. Based on the indication of the delivery problem, switch 516 may generate a data packet to include a delivery error message (e.g., routing error). This message may be included in an event packet described in the Advanced Switching specification as a Protocol Interface 5 or PI-5 event packet. The PI-5 event packet may be received by endpoint node 512 and any encoded error messages may serve as a trigger to indicate the data transmitted using the connection associated with the destination has delivery problems. As described above, a connection manager 120 may detect this trigger and proceed to modify the connection and then enable endpoint node 512 to use the modified connection based on the trigger. In this example, the modified connection may include a different network address for the destination. This different network address may be port 2 on endpoint node 522. As a result, the modified connection would be routed through switch 534 instead of switch 532 to reach the network address for port 2 on endpoint node 522. Any software that may be providing management/control service to elements of network 530 may then be notified by endpoint node 512 or endpoint node 522 to indicate that the connection associated with the destination has been modified.

In another example of a PICMG 3.4 implementation, a connection manager 120 may extract Protocol Interface (PI) information (in addition to PI-5) that may be included in the PI-5 event packet. This extracted PI information may enable connection manager 120 to select specific actions based on the one or more other PIs that may be indicated in the PI-5 event packet. In one example, as described more below, the filter policy may include PI specific policies to determine whether a modification to a connection is warranted or needed.

In another PICMG 3.4 implementation, endpoint node 512 may be an ingress node for electronic system 500 to encapsulate and tunnel SONET data traffic though network 530 to endpoint node 522 that may be an egress node for electronic system 500. In this implementation, endpoint node 512 may use a framer device (not shown) on board 510. Endpoint node 512 may monitor the health of the framer device (e.g., through a side-band communication link) and based on an indication of a problem or failure, modifies the connection to route the SONET traffic through endpoint node 514 so that endpoint node 514 become the egress node. Thus, the failure indication is the trigger and the destination (egress node) is changed to have a network address for port 1 on endpoint node 514 instead of a port on endpoint node 522.

Referring again to memory 130 and memory 230 in FIG. 1 and FIG. 2. Memory 130 or memory 230 may include a wide variety of memory media including but not limited to volatile memory, non-volatile memory, flash, programmable variables or states, random access memory (RAM), read-only memory (ROM), flash, or other static or dynamic storage media. In one example, machine-readable instructions or content can be provided to memory 130 or memory 230 from a form of machine-accessible medium. A machine-accessible medium may represent any mechanism that provides (i.e., stores or transmits) information in a form readable by a machine (e.g., an ASIC, special function controller or processor, FPGA or other hardware device). For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like.

In the previous descriptions, for the purpose of explanation, numerous specific details were set forth in order to provide an understanding of this disclosure. It will be apparent that the disclosure can be practiced without these specific details. In other instances, structures and devices were shown in block diagram form in order to avoid obscuring the disclosure.

References made in the specification to the term “responsive to” are not limited to responsiveness to only a particular feature or structure. A feature may also be “responsive to” another feature or structure and also be located within that feature or structure. Additionally, the term “responsive to” may also be synonymous with other terms such as “communicatively coupled to” or “operatively coupled to,” although the term is not limited in his regard.

What is claimed is:

1. In an endpoint node coupled to a network, a method comprising:
detecting a trigger indicating data transmitted using a connection associated with a destination is undeliverable, the connection including an egress port to transmit the data from the endpoint node and a network address for the destination;
modifying the connection based, at least in part, on detecting the trigger, wherein modifying the connection includes at least one selected from the following group of:
modifying the connection to include a different egress port to transmit the data from the endpoint node,
modifying the connection to include a different network address for the destination,
modifying the connection to include a different egress port to transmit the data from the endpoint node and a different network address for the destination; and
transmitting the data using the modified connection.

2. A method according to claim 1, wherein detecting the trigger comprises detecting the trigger via an in-band communication link, the in-band communication link coupled to an ingress port on the endpoint node.

3. A method according to claim 2, wherein the trigger is a delivery error message included in a data packet.

4. A method according to claim 1, wherein detecting the trigger comprises detecting the trigger via a side-band communication link, the side-band communication link to couple the endpoint node to a device that facilitates the transmission of the data to the destination.

5. A method according to claim 1, wherein modifying the connection is also based at least in part on a filter policy, the filter policy to include criteria to determine whether to modify the connection and transmit the data using the modified connection.

6. A method according to claim 1, wherein the trigger is from a switch that forwards data transmitted by the endpoint node to the destination.

7. A method according to claim 6, wherein the switch and the endpoint node operate in compliance with the Advanced Switching specification, the switch to generate a Protocol Interface 5 (PI-5) event packet based on an indication that the data is undeliverable to the destination.

8. A method according to claim 1, further comprising:
modifying at least one other connection based on the trigger indicating data transmitted using the connection associated with the destination is undeliverable.

9. A method according to claim 1, wherein modifying the connection further includes:
accessing a table in a memory, the table including,
a connection entry for the connection associated with the destination, the connection entry including,
at least two tuples, each tuple associated with an index identifier and including information to indicate an egress port to transmit the data and a network address for the destination,
a status table to indicate an active index value, the active index value to indicate which tuple associated with an index identifier that equals the active index value is the active tuple for the connection; and
modifying the active index value in the status table, the modification to result in a different active tuple, the different active tuple to include different information from the previously active tuple, wherein the different information indicates at least one selected from the following group of: a different egress port to transmit the data, a different network address for the destination, a different egress port and a different network address for the destination.

10. An endpoint node coupled to a network comprising:
a connection manager to include switchover logic to:
detect a trigger indicating data transmitted to a destination using a connection associated with the destination is undeliverable, the connection to include an egress port to transmit the data from the endpoint node and a network address for the destination,
modify the connection based, at least in part, on the detected trigger, the modification to include at least one selected from the following group of:
modify the connection to include a different egress port to transmit the data from the endpoint node,
modify the connection to include a different network address for the destination,
modify the connection to include a different egress port to transmit the data from the endpoint node and a different network address for the destination, and
enable the endpoint node to switchover and transmit the data using the modified connection.

11. An endpoint node according to claim 10, wherein to detect the trigger comprises to detect the trigger via an in-band communication link, the in-band communication link coupled to an ingress port on the endpoint node.

12. An endpoint node according to claim 11, wherein the trigger is an error message included in a data packet received via the in-band communication link.

13. An endpoint node according to claim 10, wherein to detect the trigger comprises to detect the trigger via a side-band communication link, the side-band communication link to couple the endpoint node to a device that facilitates the transmission of the data to the destination.

14. An endpoint node according to claim 10, wherein to modify the connection further includes the switchover logic to:
access a table in a memory, the table including,
a connection entry for the connection associated with the destination, the connection entry including,
at least two tuples, each tuple associated with an index identifier and including information to indicate an egress port to transmit the data and a network address for the destination,
a status table to indicate an active index value, the active index value to indicate which tuple associated with an index identifier that equals the active index value is the active tuple for the connection; and
modify the active index value in the status table, the modification to result in a different active tuple, the different active tuple to include different information from the previously active tuple, wherein the different information indicates at least one selected from the following group of: a different egress port to transmit the data, a different network address for the destination, a different egress port and a different network address for the destination.

15. An endpoint node according to claim 10, wherein the trigger is from a switch that forwards data transmitted by the endpoint node to the destination.

16. An endpoint node according to claim 15, wherein the switch and the endpoint node operate in compliance with the Advanced Switching specification, the switch to:
generate a Protocol Interface 5 (PI-5) event packet based on an indication that the data is undeliverable to the destination, the PI-5 event packet to include a routing error message and one or more additional Protocol Interface indications,
transmit the PI-5 event packet to the endpoint node, the PI-5 event packet to be the trigger.

17. An endpoint node according to claim 16, wherein to modify the connection is also based, at least in part, on a filter policy, the filter policy to include Protocol Interface specific criteria to determine whether to modify the connection and transmit the data using the modified connection, the Protocol Interface criteria to be applied based on the one or more Protocol Interface indications included in the PI-5 event packet.

18. A system comprising:
a switch; and
an endpoint node, the endpoint node and the switch to couple together via a communication link on a network, the endpoint node to transmit data through the switch to a destination using ca connection associated with the destination, the connection to include an egress port to transmit the data from the endpoint node and a network address for the destination, wherein based, at least in part, on an indication by the switch that the data transmitted using the connection is undeliverable, switchover logic in the endpoint node is to enable the endpoint node to transmit the data using the modified connection, the modified connection to include at least one selected from the following group of:
a different egress port to transmit the data from the endpoint node,
a different network address for the destination,
a different egress port to transmit the data from the endpoint node and a different network address for the destination.

19. A system according to claim 18, wherein the indication by the switch that the data transmitted using the connection is undeliverable comprises an indication received by the endpoint node via a side-band communication link, the side-band communication link to couple the endpoint node to the switch.

20. A system according to claim 18, wherein the indication by the switch that the data transmitted using the connection is undeliverable comprises an indication received by the endpoint node via an in-band communication link, the in-band communication link to couple the v switch to an ingress port on the endpoint node.

21. A system according to claim 20, wherein the switch and the endpoint node operate in compliance with the Advanced Switching specification, the switch to:
generate a Protocol Interface 5 (PI-5) event packet based on an indication that the data is undeliverable to the destination, the PI-5 event packet to include a routing error message and one or more additional Protocol Interface indications,
transmit the PI-5 event packet to the endpoint node, the PI-5 event packet to be the trigger.

22. A system according to claim 21, wherein the switch and the endpoint node are to couple to a backplane in a modular computing platform, the switch, the endpoint node and the backplane to operate in compliance with the Advanced Telecommunications Computing Architecture specification.

23. A machine-accessible medium comprising content, which, when executed by a machine causes the machine to:
detect a trigger indicating the data transmitted using a connection associated with a destination is undeliverable, the connection including an egress port to transmit the data from the endpoint node and a network address for the destination;
modify the connection based, at least in part, on detection of the trigger, wherein to modify the connection includes at least one selected from the following group of:
modify the connection to include a different egress port to transmit the data from the endpoint node,
modify the connection to include a different network address for the destination,
modify the connection to include a different egress port to transmit the data from the endpoint node and a different network address for the destination; and
transmit the data using the modified connection.

24. A machine-accessible medium according to claim 23, wherein to detect the trigger comprises to detect the trigger via an in-band communication link, the in-band communication link coupled to an ingress port on the endpoint node.

25. A machine-accessible medium according to claim 24, wherein the trigger is a delivery error message included in a data packet.

26. A machine-accessible medium according to claim 23, wherein to detect the trigger comprises to detect the trigger via a side-band communication link, the side-band communication link to couple the endpoint node to a device that facilitates the transmission of 4 the data to the destination.

27. A machine-accessible medium according to claim 23, wherein to modify the connection is also based at least in part on a filter policy, the filter policy to include criteria to determine whether to modify the connection and transmit the data using the modified connection.

28. A machine-accessible medium according to claim 23, wherein the trigger is from a switch that forwards data transmitted by the endpoint node to the destination.

29. A machine-accessible medium according to claim 23, wherein to modify the connection further includes to:
access a table in a memory, the table including,
a connection entry for the connection associated with the destination, the connection entry including,
at least two tuples, each tuple associated with an index identifier and including information to indicate an egress port to transmit the data and a network address for the destination,
a status table to indicate an active index value, the active index value to indicate which tuple associated with an index identifier that equals the active index value is the active tuple for the connection; and
modify the active index value in the status table, the modification to result in a different active tuple, the different active tuple to include different information from the previously active tuple, wherein the different information indicates at least one selected from the following group of: a different egress port to transmit the data, a different network address for the destination, a different egress port and a different network address for the destination.
